(19) United States
(12) Patent Application Publication
(10) Pub. No.: US 2022/0138487 A1
(43) Pub. Date: May 5, 2022

(54) DATA FILTERING SYSTEM, DATA SELECTION METHOD AND STATE PREDICTION SYSTEM USING SAME

(71) Applicant: INSTITUTE FOR INFORMATION INDUSTRY, Taipei City (TW)

(72) Inventors: Chun-Peng CHANG, Taipei City (TW); Yung-Chieh HUNG, Taipei City (TW)

(73) Assignee: INSTITUTE FOR INFORMATION INDUSTRY, Taipei City (TW)

(21) Appl. No.: 17/108,487

(22) Filed: Dec. 1, 2020

(30) Foreign Application Priority Data
Nov. 5, 2020 (TW) 109138644

(51) Int. Cl. G06K 9/62; G06N 20/00; G06F 7/36

(52) U.S. Cl. CPC G06K 9/623; G06F 7/36; G06N 20/00; G06K 9/6289

(57) ABSTRACT

A data filtering system, a data selection method, and a state prediction system are provided. The state prediction system includes the data filtering system and a predictive model generation system. The data filtering system includes a data pre-processing device and a property selection device. The data pre-processing device transforms first sample data corresponding to a first detection property into first feature parameters, transforms second sample data corresponding to a second detection property into second feature parameters, and transforms third sample data corresponding to a third detection property into third feature parameters. The property selection device selects at least two of the detection properties according to the first feature parameters, the second feature parameters, and the third feature parameters. Then, the predictive model generation system trains a predictive model based on the at least two detection properties selected by the property selection device.

### This application claims the benefit of Taiwan application Serial No. 109138644, filed Nov. 5, 2020, the subject matter of which is incorporated herein by reference.

### BACKGROUND OF THE INVENTION

### Field of the Invention

The disclosure relates in general to a data filtering system, a data selection method and a state prediction system using the data filtering system and the data selection method, and more particularly to a data filtering system, a data selection method and a state prediction system which raise the training speed of a predictive model by filtering the detection properties according to their merit scores.

### Description of the Related Art

With the development in green energy, solar power, which is the conversion of energy from sunlight into electricity, overgrows. However, the solar panel is likely to be subjected to contaminants, degradation, or element failure, which adversely lowers the solar cell efficiency, and the degraded solar panel needs to be replaced. The state of the solar panel is determined by an individual person according to his experience. Such manual determination is somewhat both inefficient and inaccurate. Therefore, it is desired to seek an automatic standardized method to determine the states of respective solar panels in the solar power field so as to increase the overall efficiency of the solar power field.

### SUMMARY OF THE INVENTION

The disclosure is directed to a data filtering system, a data selection method, and a state prediction system using the data filtering system and the data selection method. When a predictive mode generation system generates a predictive model, the predictive model is not an optimized one because of big and messy detection data are used, or it will take a long time to generate an acceptable predictive model. The data filtering system, the data selection method, and the state prediction system of the present disclosure analyze the detection properties of the detection data to provide an analysis result to the predictive model generation system, so as to raise the speed of generating the predictive model with improved accuracy.

According to a first aspect of the present disclosure, a data filtering system is provided. The data filtering system is in communication with a predictive model generation system for training a predictive model. The data filtering system includes a data pre-processing device and a property selection device. The data pre-processing device transforms first sample data corresponding to a first detection property into first feature parameters, transforms second sample data corresponding to a second detection property into second feature parameters, and transforms third sample data corresponding to a third detection property into third feature parameters. The property selection device selects at least two of the detection properties according to the first feature parameters, the second feature parameters, and the third feature parameters. The predictive model generation system trains the predictive model based on the at least two detection properties selected by the property selection device.

According to a second aspect of the present disclosure, a data selection method applied to the data filtering system is provided. The data filtering system is in communication with a predictive model generation system for training a predictive model. The data selection method includes the following steps. At first, the method transforms first sample data corresponding to a first detection property into first feature parameters, transforms second sample data corresponding to a second detection property into second feature parameters, and transforms third sample data corresponding to a third detection property into third feature parameters. Subsequently, the method selects at least two of the detection properties according to the first feature parameters, the second feature parameters and the third feature parameters. The selected detection properties are transmitted to the predictive model generation system to train the predictive model based on the selected detection properties.

According to a third aspect of the present disclosure, a state prediction system is provided. The state prediction system includes a data filtering system and a predictive model generation system. The data filtering system includes a data pre-processing device and a property selection device. The data pre-processing device transforms first sample data corresponding to a first detection property into first feature parameters, transforms second sample data corresponding to a second detection property into second feature parameters, and transforms third sample data corresponding to a third detection property into third feature parameters. The property selection device selects at least two of the detection properties according to the first feature parameters, the second feature parameters, and the third feature parameters. The predictive model generation system trains the predictive model based on the detection properties selected by the property selection device.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram illustrating a state prediction system set in a solar power field.

FIG. 2 is a sequence diagram of generating a predictive model with the state prediction system in connection with the solar panel.

FIG. 3 is a block diagram illustrating the data filtering system.

FIG. 4 is a schematic diagram illustrating that the data filtering system processes and transforms the sample data, taking the detection property DP1 as an example, into feature parameters.

FIGS. 5A, 5B, and 5C are sequence diagrams illustrating that the data filtering system generates and provides the candidate combinations of detection properties to the predictive model generation system after analyzing the sample data.

### DETAILED DESCRIPTION OF THE INVENTION

For exactly tracking the states of the solar panels in the solar power field, the present disclosure provides a state prediction system for predicting the states of the solar panels. At first, a detection module is set in the solar power field to detect the detection properties in connection with the usage states of the solar panels. Subsequently, the predictive model generation system builds a predictive model according to the detection properties. Once a predictive model is built, the predictive model starts to analyze the solar panels' degradation and failure to reduce the maintenance workforce and cost and raise the conversion efficiency of the photovoltaic (PV) cells. Furthermore, for speeding up the training of the predictive model, the present disclosure provides a data filtering system for filtering the data to be inputted to the predictive model generation system in order to raise the training speed and the accuracy of the predictive model.

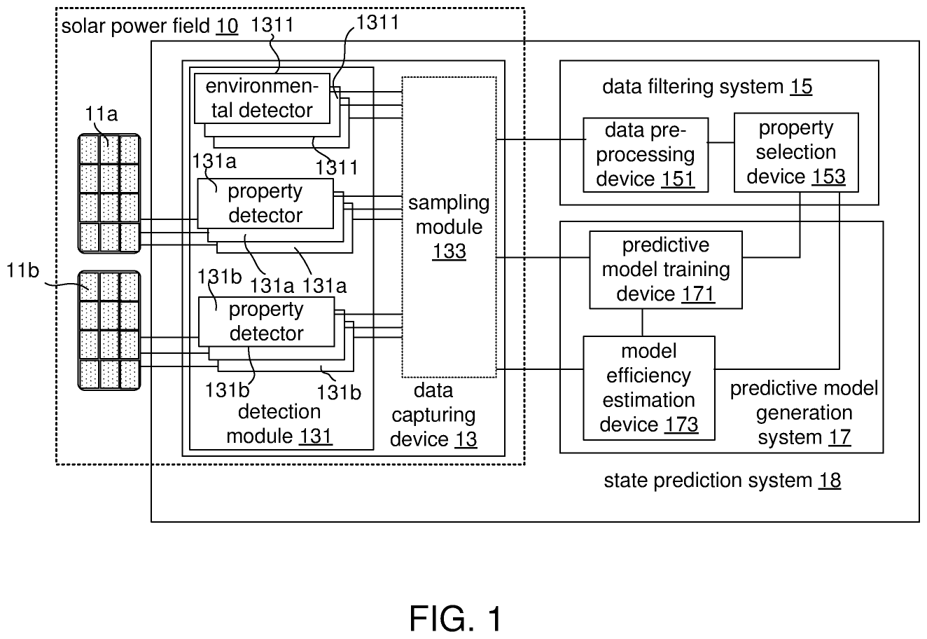

Please refer to FIG. 1, which is a block diagram illustrating a state prediction system set in a solar power field. Solar panels 11a, 11b and a detection module 131 are installed in the solar power field 10. In fact, the solar power field 10 may include a lot of solar panels. For illustration purposes only, it is assumed that there are K solar panels in the solar power field 10, and only two solar panels 11a and 11b are shown in the diagram, but the number of the solar panels is not limited in the present disclosure.

The detection module 131 includes detectors which are classified into environmental detectors 1311 and property detectors 131a, 131b. The environmental detectors 1311 are configured to detect the environmental parameters (EP) such as solar irradiance, temperature, humidity, atmospheric dust deposition, and wind speed in the solar power field 10 where the solar panels 11a and 11b are located. The detection result corresponds to all of the solar panels 11a and 11b in the solar power field 10 because the environmental detectors 1311 detect environmental conditions of the solar power field 10. For illustration purposes only, the detection module 131 includes M environmental detectors 1311 in this embodiment.

The property detectors 131a and 131b correspond to respective solar panels. For example, the solar panel 11a corresponds to the property detector 131a, and the solar panel 11b corresponds to the property detector 131b. Alternatively, one solar panel could correspond to multiple property detectors for detecting the basic properties (BP) of the solar panel, such as panel temperature, voltage, current, power, total voltage, total current, and total power. For illustration purposes only, N property detectors are provided for each solar panel.

Although the detection module 131 set in the solar power field 10 can reflect the usage state of the solar panels 11a and 11b, the great number of detectors continuously generate huge detection data, and it is a troublesome problem. A key issue is to determine which detection data are relevant to the states of the solar panels 11a and 11b to correctly predict the usage states of the solar panels 11a and 11b.

In the predictive model generation system 17, when data corresponding to too many detection properties are inputted to the predictive model training device 171 to train the predictive model, the predictive model has considerable complexity, and overfitting most likely occurs. Therefore, how to reduce the irrelevant feature and the redundant feature for the predictive model training device 171 to increase the training speed is an important issue.

For simplifying the training of the predictive model, the present disclosure further provides a data filtering system 15 used with the predictive model generation system 17. In brief, the data filtering system 15 analyzes the detection data generated by a data capturing device 13 in advance, and then provides the detection data encompassing fewer detection properties to the predictive model generation system 17. Accordingly, the predictive model training device 171 and the model efficiency estimation device 173 receives fewer detection data from the data capturing device 13 than before so as to increase the training speed of the predictive model.

As shown in FIG. 1, the state prediction system 18 used with the solar panels includes the data capturing device 13, the data filtering system 15, and the predictive model generation system 17. The present disclosure does not limit the practical form and architecture of the state prediction system 18 for the solar panels. For example, the state prediction system 18 for the solar panels is disposed in the solar power field 10; only the detection module 131 is disposed in the solar power field 10; or one portion of the state prediction system 18 is disposed in the solar power field 10, and the other portion is disposed in another site wherein two portions are in communication with each other through a network. The elements of the state prediction system 18 used with the solar panels described in the embodiments of the present disclosure could be implanted by software, hardware, or their combination.

The data filtering system 15 includes a data pre-processing device 151 and a property selection device 153. The predictive model generation system 17 includes a predictive model training device 171 and a model efficiency estimation device 173. It is to be noted that in the specification, the modules, devices, and systems could be in communication with or electrically connected to each other. The signal transmission media and protocols are not limited to the described embodiments.

Referring to the above example, there are K solar panels in the solar power field 10. Thus, the detection module 131 may include M environmental detectors 1311 and N*K property detectors 131a, 131b, wherein M, N, K are positive integers. The following example is described based on four environmental detectors (M=4) in the solar power field 10 and two property detectors (N=2) for each solar panel. For each solar panel, the detection properties of the detection data obtained by the detectors are collected and shown in Table 1.

TABLE 1

| Detection | | |
|---|---|---|
| property | Detection parameter | Attribute |
| DP1 | Solar irradiance | EP of solar |
| DP2 | Humidity | power field |
| DP3 | Atmospheric dust | |
| | deposition | |
| DP4 | Temperature | |
| DP5 | Voltage | BP of solar |
| DP6 | Current | panel |

In some cases, the detectors (for example, detectors 1311, 131a, and 131b) of the detection module 131 are set to have equal sampling frequency (sample rate), so an additional sampling module is not required. In other cases, the detectors generate raw detection data at different frequencies. For example, one detector may generate one piece of raw detection data every ten seconds, and another detector may generate one piece of raw detection data every minute. In these cases, the data capturing device 13 further includes a sampling module 133 for sampling the raw detection data at equal intervals to generate sample data. The sampling module 133 generates the sample data at a specific sampling frequency (for example, every five minutes) within a specific detection duration (for example, one day).

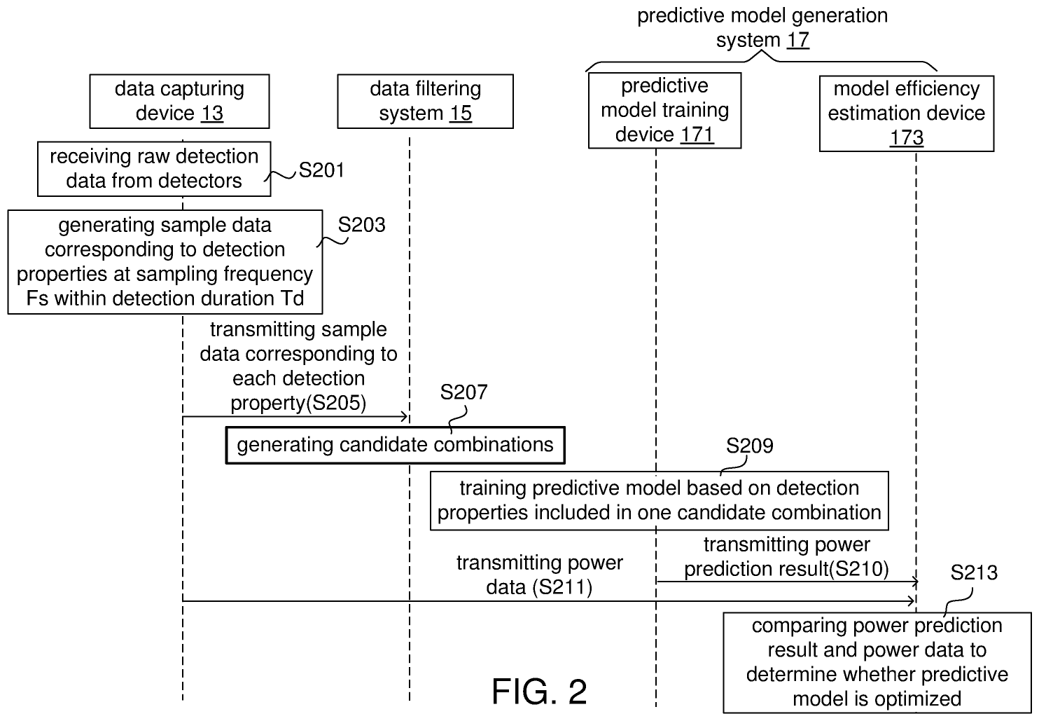

Please refer to FIG. 2, which is a sequence diagram of generating a predictive model with the state prediction system in connection with the solar panels. At first, the data capturing device 13 receives the raw detection data generated by the detectors (step S201), and generates the sample data at a sampling frequency Fs within a detection duration Td (step S203). The data capturing device 13 sends the sample data corresponding to each detection property to the data filtering system 15 (step S205).

Using the values given in the foregoing, the detection duration Td is set as one day, and the sampling frequency Fs is set as per five minutes. Accordingly, after one day's detection, 288 sample data (12*24=288) corresponding to each detection property DP1˜DP6 are generated. In other words, the data capturing device 13 generates and transmits 288 sample data corresponding to the detection property DP1 to the data filtering system 15, generates and transmits 288 sample data corresponding to the detection property DP2 to the data filtering system 15, generates and transmits 288 sample data corresponding to the detection property DP3 to the data filtering system 15, generates and transmits 288 sample data corresponding to the detection property DP4 to the data filtering system 15, generates and transmits 288 sample data corresponding to the detection property DP5 to the data filtering system 15, and generates and transmits 288 sample data corresponding to the detection property DP6 to the data filtering system 15.

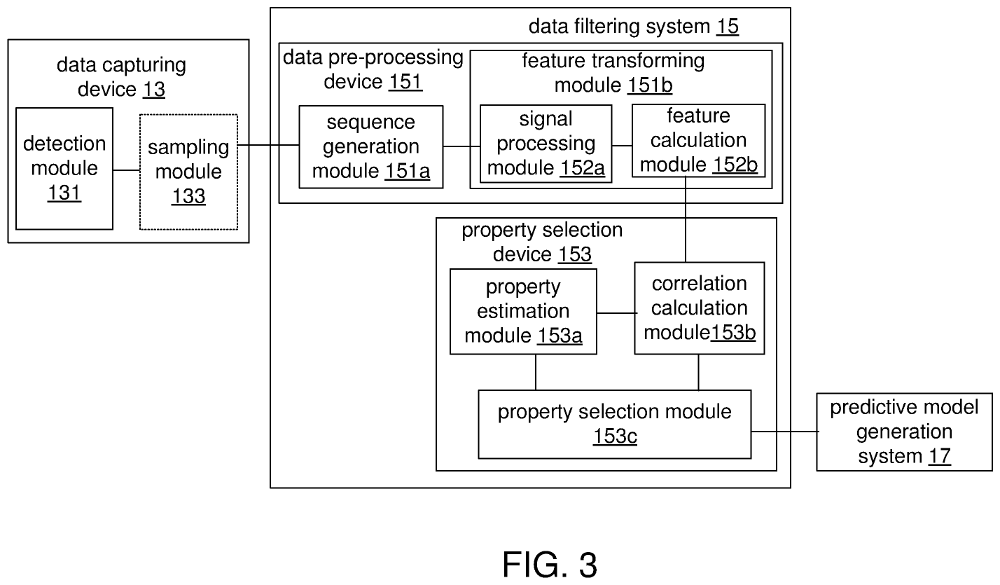

After receiving the sample data corresponding to the detection properties DP1˜DP6, the data filtering system 15 generates a plurality of candidate combinations (step S207) according to the received sample data. Each candidate combination consists of at least two, but not all, of detection properties DP1˜DP6. The details about step S207 performed by the data filtering system 15 will be described with reference to FIGS. 3, 4, 5A, 5B, and 5C later. After generating the candidate combinations, the data filtering system 15 transmits all of the detection properties included in the candidate combinations to the predictive model training device 171, and the model efficiency estimation device 173.

Afterward, the predictive model training device 171 uses the detection properties included in one candidate combination to train the predictive model (step S209). At this time, the data capturing device 13 further generates model training data corresponding to the detection properties included in the candidate combination within a model training detection duration Ttd (for example, one week), and then transmits the model training data to the predictive model training device 171. The predictive model training device 171 uses the model training data to train the predictive model to generate a power prediction result, and then transmits the power prediction result to the model efficiency estimation device 173 (step S210). The details about how the predictive model training device 171 uses the model training data to train the predictive model based on the detection properties of the candidate combination are not particularly described herein, and the user can perform the training in applications with individual settings as desired.

The model efficiency estimation device 173 also receives power data from the data capturing device 13 generated within the model training detection duration Ttd (step S211). Then, the model efficiency estimation device 173 compares the power prediction result with the power data to get the prediction error (step S213).

If the prediction error is less than or equal to a predetermined error threshold, the model efficiency estimation device 173 determines that the predictive model currently trained by the predictive model training device 171 has been optimized. Therefore, the predictive model training device 171 has finished training the predictive model. At this time, the state prediction system 18 for the solar panels can use the current predictive model to predict the state of the solar power field 10.

Otherwise, if the prediction error is still greater than the predetermined error threshold, the model efficiency estimation device 173 determines that the predictive model currently trained by the predictive model training device 171 does not achieve optimization. There are two possible conditions at this time.

One condition is that the candidate combinations generated by the data filtering system 15 are not consumed completely. Thus, the predictive model training device 171 picks another candidate combination to train the predictive model, and the model efficiency estimation device 173 estimates the predictive model trained with the new model training data. The steps S209 and S213 are repetitively performed, but the step S211 could be selectively performed to repetitively transmit the power data or not.

The other condition is that all the candidate combinations generated by the data filtering system 15 have been consumed to train the predictive model, but no optimum predictive model is obtained according to the candidate combinations. Thus, the data filtering system 15 would generate other candidate combinations for the predictive model generation system 17 (back to step S207). Otherwise, the data capturing device 13 sets a new detection duration Td and a new sampling frequency Fs to perform all of the steps again in FIG. 2.

By the way, the predictive model is built for individual solar panel in the description. However, since the neighboring solar panels (for example, arranged in the same column) in one solar power field 10 usually have a uniform specification, the predictive model can be applied to the neighboring solar panels for prediction to speed up the training of the predictive model.

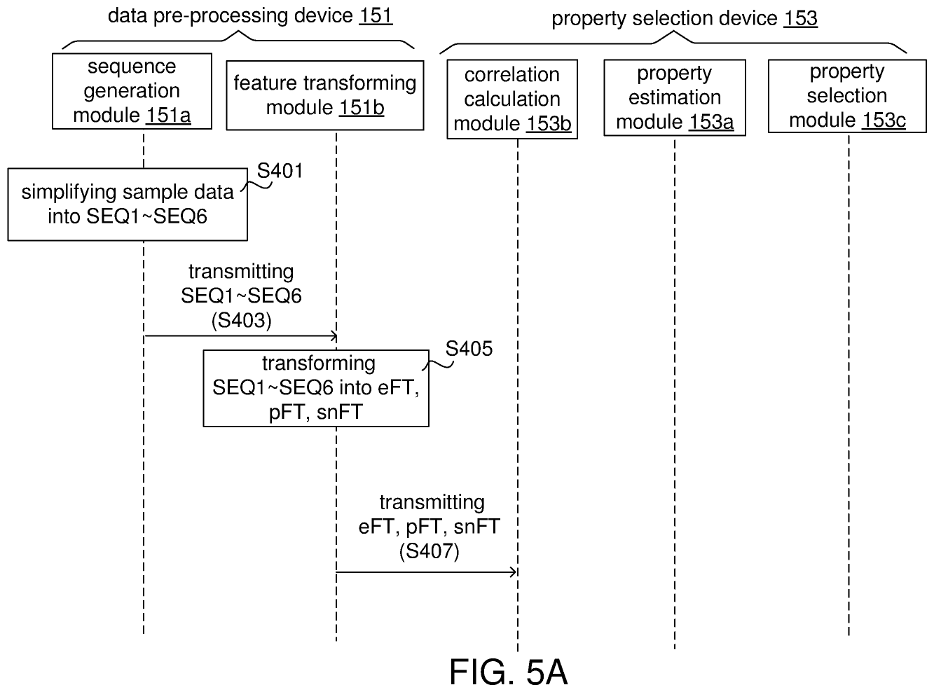

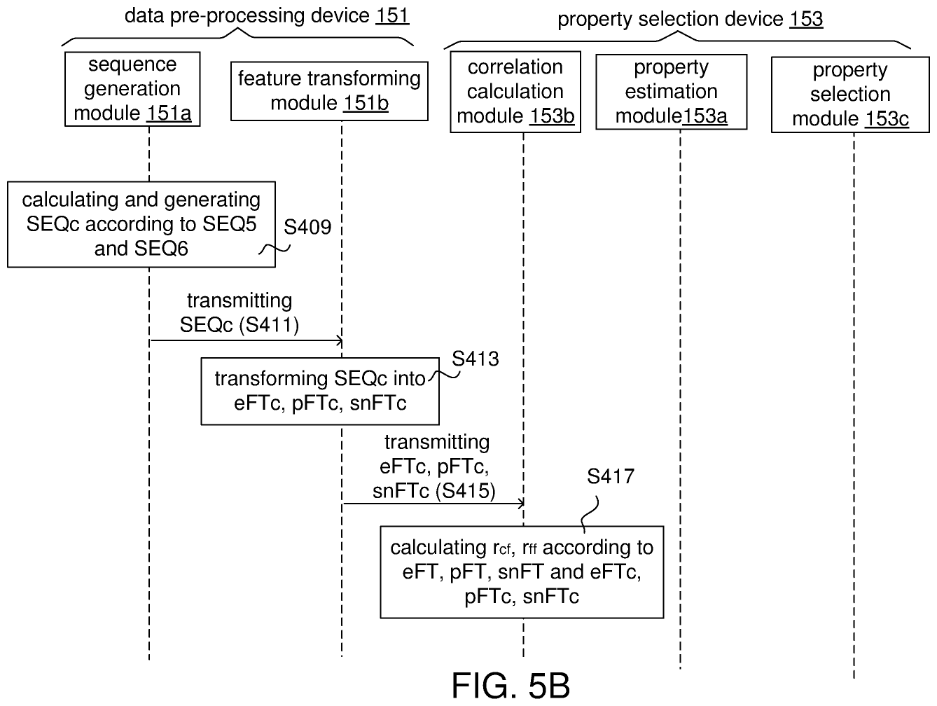

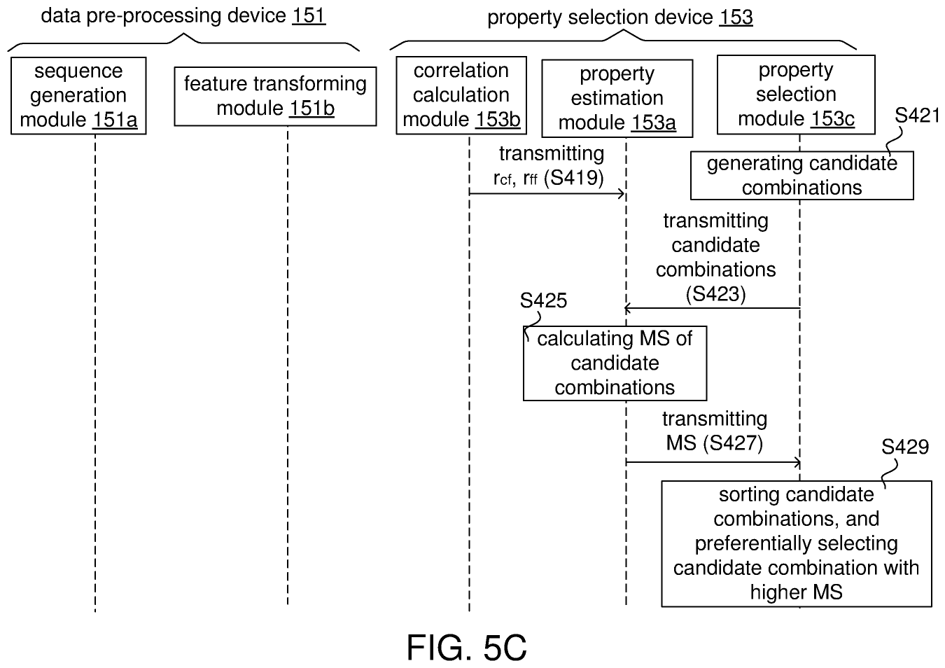

Please refer to FIG. 3, which is a block diagram illustrating the data filtering system. The data filtering system 15 includes a data pre-processing device 151 and a property selection device 153. The data pre-processing device 151 includes a sequence generation module 151a and a feature transforming module 151b in communication with each other. The property selection device 153 includes a correlation calculation module 153b, a property estimation module 153a, and a property selection module 153c in communication with each other. The feature transforming module 151b further includes a signal processing module 152a and a feature calculation module 152b in communication with each other. The signal processing module 152a is in communication with the sequence generation module 151a, and the feature calculation module 152b is in communication with the correlation calculation module 153b. The sequence generation module 151a is in communication with the data capturing device 13, the feature transforming module 151b is in communication with the correlation calculation module 153b, and the property selection module 153c is in communication with the predictive model generation system 17. FIGS. 5A, 5B, and 5C illustrate the operation of the data filtering system 15.

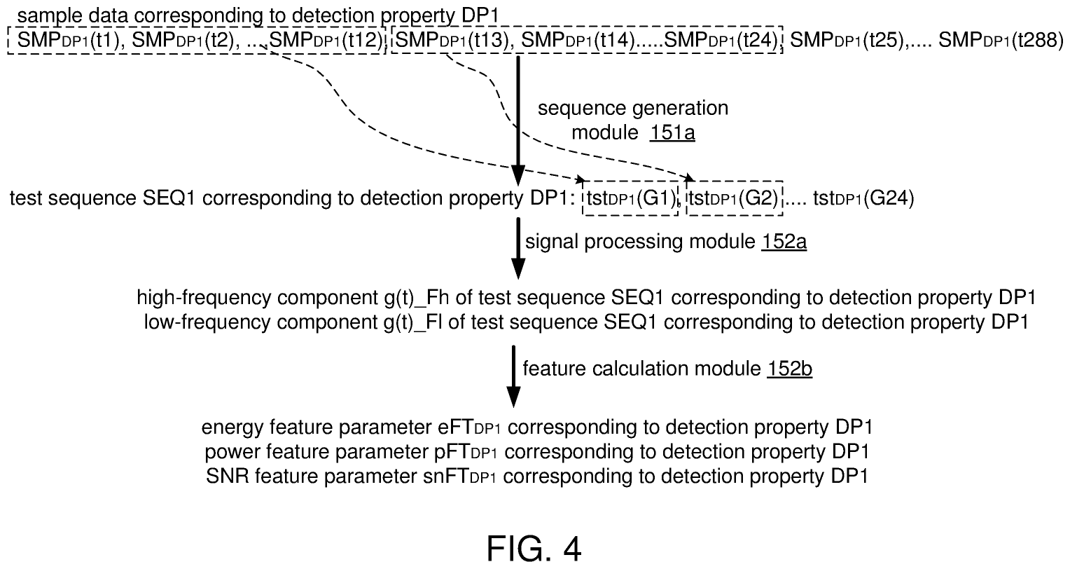

According to an embodiment of the present disclosure, in the data filtering system 15, the data pre-processing device 151 mainly processes and transforms the detection data corresponding to respective detection properties DP1˜DP6, and the property selection device 153 analyzes the correlation between different detection properties DP1˜DP6. Only the detection property DP1 is taken to describe how the data pre-processing device 151 processes the detection data corresponding to respective detection properties DP1˜DP6. FIG. 4 illustrates that the data filtering system 15 processes and transforms the sample data SMP_{DP1}(t1)˜SMP_{DP1}(t288) into feature parameters eFT_{DP1}, pFT_{DP1}, and snFT_{DP1}. The procedures of processing and transforming the detection data in FIG. 4 are described in the following with reference to FIG. 5A.

Please refer to FIGS. 5A, 5B, and 5C, which are sequence diagrams illustrating that the data filtering system generates and provides the candidate combinations of detection properties to the predictive model generation system after analyzing the sample data. The parallel vertical lines (lifelines) show the time sequence of steps. However, the steps may be performed simultaneously with different elements, or the time sequence is sometimes alterable. The modules of the data pre-processing device 151 and the property selection device 153 are shown at the head of the lifelines in FIGS. 5A, 5B, and 5C. In these diagrams, one action along the dashed line connected to a specific module is performed by the corresponding module. The horizontal arrow between two dashed lines represents that the action involves data transmission between two modules.

At first, the sequence generation module 151a simplifies the sample data corresponding to each detection property DP1˜DP6 to provide test sequence SEQ1˜SEQ6 (step S401). Following the foregoing example, the sequence generation module 151a receives 288 sample data corresponding to each detection property DP1˜DP6 from the sampling module 133. Now referring to FIG. 4, there are 288 sample data SMP_{DP1}(t1)˜SMP_{DP1}(t288) corresponding to the detection property DP1. These sample data SMP_{DP1}(t1)˜SMP_{DP1}(t288) correspond to the detection duration Td, that is, one day. Then, the sequence generation module 151a defines a length of a sequence interval Tsint, and generates one record of sequence data for each sequence interval Tsint, for example, sequence data tst_{DP1}(G1)˜tst_{DP1}(G24) correspond to 24 sequence intervals in FIG. 4.

For example, the length of sequence interval Tsint is defined as one hour, and the detection duration Td is equivalent to 24 sequence intervals Tsint. Therefore, the 288 sample data SMP_{DP1}(t1)˜SMP_{DP1}(t288) corresponding to the detection property DP1 are distributed in 24 sequence intervals Tsint so that one sequence interval Tsint corresponds to 12 records of sample data SMP_{DP1}(t1)˜SMP_{DP1}(t288) corresponding to the detection property DP1. Therefore, the test sequence SEQ1 corresponding to the detection property DP1 includes 24 sequence data tst_{DP1}(G1)˜tst_{DP1}(G24) in total. For example, the sequence data tst_{DP1}(G1) is generated according to the sample data SMP_{DP1}(t1)˜SMP_{DP1}(t12); and the sequence data tst_{DP1}(G2) is generated according to the sample data SMP_{DP1}(t13)˜SMP_{DP1}(t24).

The sequence generation module 151a obtains the sequence data corresponding to each sequence interval Tsint according to a predefined sequence data formula, for example, average value, maximum value, minimum value, or random value of the sample data. Therefore, the sequence generation module 151a generates test sequences SEQ1˜SEQ6, each including 24 sequence data, corresponding to detection properties DP1˜DP6, respectively.

Subsequently, the sequence generation module 151a transmits the test sequences SEQ1˜SEQ6 corresponding to the detection properties DP1˜DP6 to the feature transforming module 151b (step S403). The feature transforming module 151b transforms the test sequences SEQ1˜SEQ6 into feature parameters corresponding to each detection property DP1˜DP6 (step S405). Each detection property DP1˜DP6 corresponds to three feature parameters, that is, energy feature parameter eFT, power feature parameter pFT, and signal-to-noise ratio (SNR) feature parameter snFT.

According to the present disclosure, the feature transforming module 151b has two operation stages. In the first stage, the signal processing module 152a transforms the test sequences SEQ1˜SEQ6 through spectral analysis (for example, wavelet transform, Hilbert-Huang transform (HHT) and Fourier transform (FT)) into a high-frequency component g(t)_Fh and a low-frequency component g(t)_Fl. In the second stage, the feature calculation module 152b generates the energy feature parameter eFT, the power feature parameter pFT, and the SNR feature parameter snFT corresponding to each detection property DP1˜DP6 according to the high-frequency component g(t)_Fh and the low-frequency component g(t)_Fl of each test sequence SEQ1˜SEQ6. In Eq. (1)˜Eq. (3), the symbol T represents the detection duration Td.

The energy feature parameter eFT is calculated according to Eq. (1)

eFT=lim_{T→∞}1/2T∫_{-T}^{T}|g(t)_Fl|² (1)

The power feature parameter pFT is calculated according to Eq. (2).

$$p FT = {lim}_{T \to ∞} \frac{1}{2 T} {\int }_{- T}^{T} {\vert {g ( t )}_{-} Fl \vert}^{2} \qquad ( 2 )$$

The SNR feature parameter snFT is calculated according to Eq. (3)

$$snFT = \frac{{lim}_{T \to ∞} {\int }_{- T}^{T} {\vert {g ( t )}_{-} Fl \vert}^{2}}{{lim}_{T \to ∞} {\int }_{- T}^{T} {\vert {g ( t )}_{-} Fh \vert}^{2}} \qquad ( 3 )$$

According to the embodiment of the present disclosure, the energy feature parameter eFT and the power feature parameter pFT are calculated from the low-frequency component g(t)_Fl of the test sequence SEQ1˜SEQ6; and the SNR feature parameter snFT is calculated from both the low-frequency component g(t)_Fl and the high-frequency component g(t)_Fh of the test sequence SEQ1˜SEQ6. For illustration purposes, the subscript of the symbol denotes the detection property DP1˜DP6 of the feature parameters eFT, pFT, and snFT. For example, the energy feature parameter eFT corresponding to the detection property DP1 is expressed as eFT_{DP1}; the power feature parameter corresponding to the detection property DP1 is expressed as pFT_{DP1}; and the SNR feature parameter snFT corresponding to the detection property DP1 is expressed as snFT_{DP1}.

As shown in FIG. 4, the signal processing module 152a processes the test sequence SEQ1 corresponding to the detection property DP1 to generate the high-frequency component g(t)_Fh and the low-frequency component g(t)_Fl corresponding to the detection property DP1. Afterward, the feature calculation module 152b calculates the energy feature parameter eFT_{DP1} corresponding to the detection property DP1, the power feature parameter pFT_{DP1}corresponding to the detection property DP1, and the SNR feature parameter snFT_{DP1} corresponding to the detection property DP1 according to Eq. (1)˜Eq. (3).

Table 2 lists the low-frequency component g(t)_Fl, the high-frequency component g(t)_Fh, the energy feature parameter eFT, the power feature parameter pFT, and the SNR feature parameter snFT corresponding to each detection property DP1˜DP6.

TABLE 2

| DP | SEQ | g(t)_Fl | g(t)_Fh | eFT | pFT | snFT |
|---|---|---|---|---|---|---|
| DP1 | SEQ1 | g1(t)_Fl | g1(t)_Fh | eFT_{DP1} | pFT_{DP1} | snFT_{DP1} |
| DP2 | SEQ2 | g2(t)_Fl | g2(t)_Fh | eFT_{DP2} | pFT_{DP2} | snFT_{DP2} |
| DP3 | SEQ3 | g3(t)_Fl | g3(t)_Fh | eFT_{DP3} | pFT_{DP3} | snFT_{DP3} |
| DP4 | SEQ4 | g4(t)_Fl | g4(t)_Fh | eFT_{DP4} | pFT_{DP4} | snFT_{DP4} |
| DP5 | SEQ5 | g5(t)_Fl | g5(t)_Fh | eFT_{DP5} | pFT_{DP5} | snFT_{DP5} |
| DP6 | SEQ6 | g6(t)_Fl | g6(t)_Fh | eFT_{DP6} | pFT_{DP6} | snFT_{DP6} |

Steps S401, S403, S405, and S407 collectively transform the detection data corresponding to the detection properties DP1˜DP6 into the feature parameters. Further, the sequence generation module 151a calculates an electricity generation sequence SEQc (step S409) based on the test sequences SEQ5 and SEQ6 corresponding to the current (detection property DP5) and the voltage (detection property DP6) in the detection data according to the power formula P=I*V and the energy formula E=P*T, where P is the power, I is the current, V is the voltage and T is the time period. After the sequence generation module 151a transmits the electricity generation sequence SEQc to the feature transforming module 151b (step S411), the feature transforming module 151b also divides the electricity generation sequence SEQc into a low-frequency component and a high-frequency component and then calculates the electricity generation-feature parameters (electricity generation-energy feature parameter eFTc, electricity generation-power feature parameter pFTc and electricity generation-SNR feature parameter snFTc) according to Eq. (1)˜Eq. (3) (step S413).

The feature transforming module 151b transmits the feature parameters eFT_{DP1}˜eFT_{DP6}, pFT_{DP1}˜pFT_{DP6}, and snFT_{DP1}˜SnFT_{DP6} corresponding to the detection properties DP1˜DP6 (called property dependent-feature parameters hereinafter) and the electricity generation-feature parameters (electricity generation-energy feature parameter eFTc, electricity generation-power feature parameter pFTc and electricity generation-SNR feature parameter snFTc) to the correlation calculation module 153b (step S407 and step S415). Then, the correlation calculation module 153b calculates the property dependent-correlation coefficients r_{ff} between the feature parameters corresponding to any two of the detection properties DP1˜DP6 based on the property dependent-feature parameters eFT_{DP1}˜eFT_{DP6}, pFT_{DP1}˜pFT_{DP6}, and snFT_{DP1}˜snFT_{DP6}. Also, the correlation calculation module 153b calculates the electricity generation-correlation coefficients r_{cf} according to the property dependent-feature parameters eFT_{DP1}˜eFT_{DP6}, pFT_{DP1}˜pFT_{DP6} and snFT_{DP1}˜snFT_{DP6} and the electricity generation-feature parameters (electricity generation-energy feature parameter eFTc, electricity generation-power feature parameter pFTc and electricity generation-SNR feature parameter snFTc) (step S417). The correlation calculation module 153b calculates the property dependent-correlation coefficients r_{ff} and the electricity generation-correlation coefficients r_{cf} according to the correlation coefficient formula of Eq. (4).

$$r = \frac{{\sum }_{i = 1}^{3} ( {x}_{i} - \overline{x} ) ( {y}_{i} - \overline{y} )}{\sqrt{{\sum }_{i = 1}^{3} {( {x}_{i} - \overline{x} )}^{2} \cdot {\sum }_{i = 1}^{3} {( {x}_{i} - \overline{x} )}^{2}}} \qquad ( 4 )$$

In Eq. (4), the symbols x̅ and y̅ represent feature parameter averages, respectively. For example, the variable x represents the detection property DP1, and the variable y represents the detection property DP2. In Eq. (4), xᵢ (i=1) is defined as the energy feature parameter eFT_{DP1} corresponding to the detection property DP1, xᵢ (i=2) is defined as the power feature parameter pFT_{DP1} corresponding to the detection property DP1, and xᵢ (i=3) is defined as the SNR feature parameter snFT_{DP1} corresponding to the detection property DP1. Also, yᵢ (i=1) is defined as the energy feature parameter eFT_{DP2} corresponding to the detection property DP2, yᵢ (i=2) is defined as the power feature parameter pFT_{DP2} corresponding to the detection property DP2, and yᵢ (i=3) is defined as the SNR feature parameter snFT_{DP2} corresponding to the detection property DP2. Further, the feature parameter average corresponding to the detection property DP1 is calculated from Eq. (5), and the feature parameter average corresponding to the detection property DP2 is calculated from Eq. (6).

$$\begin{matrix}\overline{x} = \frac{{eFT}_{DP 1} + {pFT}_{DP 1} + {snFT}_{DP 1}}{3} & ( 5 ) \\ \overline{y} = \frac{{eFT}_{DP 2} + {pFT}_{DP 2} + {snFT}_{DP 2}}{3} & ( 6 )\end{matrix}$$

There is little difference between the property dependent-correlation coefficient r_{ff} and the electricity generation-correlation coefficient r_{cf}. For calculating the property dependent-correlation coefficient r_{ff}, the variables x and y correspond to two of the detection properties DP1˜DP6; while for calculating the electricity generation-correlation coefficient r_{cf}, one of the variables x and y corresponds to the electricity generation C, and the other one of the variables x and y corresponds to one of the detection properties DP1˜DP6. After calculating the property dependent-correlation coefficient r_{ff} and the electricity generation-correlation coefficient r_{cf} between the electricity generation C and each of the detection properties DP1˜DP6 as derived from Eq. (4)˜Eq. (6), an exemplified result is shown in Table 3. It is to be noted that the values are provided for illustration purposes only.

TABLE 3

| | Solar | | Dust | | | | C |
|---|---|---|---|---|---|---|---|
| | irradiance | Humidity | deposition | Temperature | Voltage | Current | (P = |
| | DP1 | DP2 | DP3 | DP4 | DP5 | DP6 | I*V) |
| Solar | 1 | r_{ff} = 0.3 | r_{ff} = 0.59 | r_{ff} = 0.19 | r_{ff} = 0.33 | r_{ff} = 0.24 | r_{cf} = 0.9 |
| irradiance | | | | | | | |
| DP1 | | | | | | | |
| Humidity | r_{ff} = 0.3 | 1 | r_{ff} = 0.5 | r_{ff} = 0.23 | r_{ff} = 0.51 | r_{ff} = 0.17 | r_{cf} = 0.4 |
| DP2 | | | | | | | |
| Dust | r_{ff} = 0.59 | r_{ff} = 0.5 | 1 | r_{ff} = 0.085 | r_{ff} = 0.24 | r_{ff} = 0.042 | r_{cf} = 0.6 |
| deposition | | | | | | | |
| DP3 | | | | | | | |
| Temperature | r_{ff} = 0.19 | r_{ff} = 0.23 | r_{ff} = 0.085 | 1 | r_{ff} = 0 | r_{ff} = 0 | r_{cf} = 0.6 |
| DP4 | | | | | | | |
| Voltage DP5 | r_{ff} = 0.33 | r_{ff} = 0.51 | r_{ff} = 0.24 | r_{ff} = 0 | 1 | r_{ff} = 0.029 | r_{cf} = 0.3 |
| Current DP6 | r_{ff} = 0.24 | r_{ff} = 0.17 | r_{ff} = 0.042 | r_{ff} = 0 | r_{ff} = 0.029 | 1 | r_{cf} = 0.8 |
| C (P = I*V) | r_{cf} = 0.9 | r_{cf} = 0.4 | R_{cf} = 0.6 | r_{cf} = 0.6 | r_{cf} = 0.3 | r_{cf} = 0.8 | 1 |

Afterward, the correlation calculation module 153b transmits the property dependent-correlation coefficients r_{ff} and the electricity generation-correlation coefficients r_{cf} to the property estimation module 153a (step S419). Besides, the property selection module 153c generates several candidate combinations consisting of specific detection properties DP1˜DP6 (step S421), and transmits the candidate combinations to the property estimation module 153a (step S423). After receiving the property dependent-correlation coefficients r_{ff} and the electricity generation-correlation coefficients r_{cf} from the correlation calculation module 153b, and receiving the candidate combinations from the property selection module 153c, the property estimation module 153a calculates a merit score (MS) of each candidate combination according to the correlation coefficients r_{ff} and r_{cf} (step S425). The property estimation module 153a calculates the merit scores of respective candidate combinations from a merit score formula expressed as Eq. (7).

$$MS = \frac{k \cdot \overline{{r}_{cf}}}{\sqrt{k + ( k - 1 ) \cdot k \cdot \overline{{r}_{ff}}}} \qquad ( 7 )$$

In Eq. (7), k is the number of the detection properties in the current candidate combination; the electricity generation-correlation coefficient average r̅_̅{̅c̅f̅}̅ is the average of all electricity generation-correlation coefficients r_{cf} in the current candidate combination; and the property dependent-correlation coefficient average r̅_̅{̅f̅f̅}̅ is the average of all property dependent-correlation coefficients r_{ff} in the current candidate combination. According to the present disclosure, higher electricity generation-correlation coefficient average r̅_̅{̅c̅f̅}̅ results in a higher merit score of the candidate combination. Furthermore, lower property dependent-correlation coefficient average r̅_̅{̅f̅f̅}̅, represents lower interaction effect between the detection properties. Accordingly, lower property dependent-correlation coefficient r_{ff} leads to a higher merit score. Therefore, the data filtering system 15 of the present disclosure will find the candidate combinations with higher electricity generation-correlation coefficients r_{cf} and lower property dependent-correlation coefficients r_{ff}.

In practical application, the candidate combinations could be selected through any proper approach. For example, the property selection module 153c arbitrarily selects a few of the detection properties DP1˜DP6. Or, the property selection module 153c selects the candidate combinations through two stages. At the first stage, all 63 (2⁶−1=63) possible combinations of the detection properties DP1˜DP6 are considered as preliminary combinations. At the second stage, the merit scores of these preliminary combinations are calculated according to the merit score formula in Eq. (7), and the preliminary combinations are sorted in order of the merit scores. The preliminary combinations with top 10 merit scores are selected as the candidate combinations.

For example, the property selection module 153c selects the detection properties DP1, DP2, and DP3 to provide a candidate combination, that is, k=3, and the electricity generation-correlation coefficients r_{cf} and the property dependent-correlation coefficients r_{ff} adopt the values listed in Table 3.

In Table 3, the electricity generation-correlation coefficient r_{cf} between the detection property DP1 (solar irradiance) and the electricity generation C is 0.9; the electricity generation-correlation coefficient r_{cf} between the detection property DP2 (humidity) and the electricity generation C is 0.4; and the electricity generation-correlation coefficient r_{cf} between the detection property DP3 (atmospheric dust deposition) and the electricity generation C is 0.6. Accordingly, the average of the electricity generation-correlation coefficients r̅_̅{̅c̅f̅}̅ is obtained by averaging the three values (Eq. (8)).

$$\overline{{r}_{cf}} = \frac{( 0.9 + 0.4 + 0.6 )}{3} = 0.63 \qquad ( 8 )$$

In Table 3, the property dependent-correlation coefficient r_{ff} between the detection property DP1 (solar irradiance) and the detection property DP2 (humidity) is 0.3; the property dependent-correlation coefficient r_{ff} between the detection property DP1 (solar irradiance) and the detection property DP3 (atmospheric dust deposition) is 0.59; and the property dependent-correlation coefficient r_{ff} between the detection property DP2 (humidity) and the detection property DP3 (atmospheric dust deposition) is 0.5. Therefore, the average of the property dependent-correlation coefficients r_{ff} is obtained by averaging the three values (Eq. (9)).

$$\overline{{r}_{cf}} = \frac{( 0.3 + 0.59 + 0.5 )}{3} = 0.463 \qquad ( 9 )$$

Subsequently, according to the merit score formula in Eq. (7), the merit score MS of this candidate combination consisting of the detection properties DP1, DP2, and DP3 is calculated according to the number k of the detection properties included in the candidate combination, the average of the electricity generation-correlation coefficients r_{cf} and the average of the property dependent-correlation coefficients r̅_̅{̅f̅f̅}̅. The merit score MS is obtained in Eq. (10).

$$MS = \frac{k \cdot \overline{{r}_{cf}}}{\sqrt{k + ( k - 1 ) \cdot k \cdot \overline{{r}_{ff}}}} = \frac{3 \cdot 0.63}{\sqrt{3 + ( 3 - 1 ) \cdot 3 \cdot 0.463}} = 0.79 \qquad ( 10 )$$

By now, the merit score MS of the candidate combination consisting of the solar irradiance (detection property DP1), the humidity (detection property DP2), and the atmospheric dust deposition (detection property DP3) is 0.79 (step S425).

Another candidate combination consisting of the detection properties DP4 and DP 6 is taken as an example. The number k of the detection properties included in the candidate combination is 2, the average of the electricity generation-correlation coefficients r̅_̅{̅c̅f̅}̅ and the average of the property dependent-correlation coefficients r̅_̅{̅f̅f̅}̅ are calculated from the correlation coefficients in Table 3.

In Table 3, the electricity generation-correlation coefficient r_{cf} between the detection property DP4 (temperature) and the electricity generation C is 0.6; and the electricity generation-correlation coefficient r_{cf} between the detection property DP6 (current) and the electricity generation C is 0.8. Accordingly, the average of the electricity generation-correlation coefficients r̅_̅{̅c̅f̅}̅ is obtained by averaging the two values (Eq. (11)).

$$\overline{{r}_{cf}} = \frac{( 0.6 + 0.8 )}{2} = 0.7 \qquad ( 11 )$$

In table 3, the property dependent-correlation coefficient r_{ff} between the detection property DP4 (temperature) and the detection property DP6 (current) is 0. Therefore, the average of the property dependent-correlation coefficients r̅_̅{̅f̅f̅}̅ is 0.

Subsequently, according to the merit score formula in Eq. (7), the merit score MS of this candidate combination consisting of the detection properties DP4 and DP6 is calculated according to the number k of the detection properties included in the candidate combination, the average of the electricity generation-correlation coefficients r̅_̅{̅c̅f̅}̅ and the average of the property dependent-correlation coefficients r̅_̅{̅f̅f̅}̅. The merit score is obtained in Eq. (12).

$$MS = \frac{k \cdot rcf}{\sqrt{k + ( k - 1 ) \cdot k \cdot rff}} = \frac{2 \cdot 0.7}{\sqrt{2 + ( 2 - 1 ) \cdot 2 \cdot 0}} = 0.99 \qquad ( 12 )$$

By now, the merit score MS of the candidate combination consisting of the temperature (detection property DP4) and the current (detection property DP6) is 0.99 (step S425). Then, the property estimation module 153a transmits the merit scores of respective candidate combinations to the property selection module 153c (step S427). The property selection module 153c sorts the candidate combinations in order of the merit scores and transmits the candidate combinations in the sorted sequence to the predictive model generation system 17 (step S429). For example, considering the two candidate combinations above, the property selection module 153c transmits the candidate combination consisting of the detection properties DP4 and DP6 to the predictive model generation system 17 first. Following the first candidate combination, the property selection module 153c transmits the candidate combination consisting of the detection properties DP1, DP2, and DP3 to the predictive model generation system 17.

As described above, the property selection module 153c transmits the candidate combination consisting of the detection properties DP4 and DP6 to the predictive model generation system 17. If the model efficiency estimation device 173 determines that the predictive model generated according to the candidate combination consisting of the detection properties DP4 and DP6 has reached optimized conditions, the property selection module 153c may stop transmitting the candidate combination consisting of the detection properties DP1, DP2, and DP3 to the predictive model generation system 17.

According to the description, the data filtering system 15 of the present disclosure filters the various detection properties before training the predictive model. Thus, the predictive model generation system 17 can generate the predictive model with optimized conditions without using all of the sample data in a large number. Therefore, the data filtering system 15 can reduce the number of detection properties required for training the predictive model. The predictive model generation system 17 can generate the predictive model with higher speed and increased accuracy. For the solar power field, it is helpful to realize the state of solar panels and raise the conversion efficiency of the solar power field.

The environmental detectors and the property detectors of the present disclosure detect the environment parameters and the property parameters continuously and automatically. The states of the solar panels can be reflected quickly with less human power. Furthermore, the data processing device and the data processing method of the present disclosure analyze the statistical data in a complicated photovoltaic field by dimensionality reduction to simplify the data required for training the predictive model, but without affecting the accuracy of the predictive model. The predictive model generation system can use the algorithms including support-vector machines (SVM), back-propagation neural networks (BPNN), or k-nearest neighbors (KNN) to predict the electricity generation C. Because the data for training the predictive model has been filtered for the purpose of removing irrelevant and redundant features in advance, the predictive model subject to the training can provide a better prediction result on the electricity generation C.

It is to be noted that the present disclosure is not limited to a state prediction system for solar panels as described in the above embodiments. For the field of electrical power generation from any other renewable energy, for example, wind power or hydropower, environmental detectors, and property detectors could be set in the field adaptively and cooperate with a data filtering system and a predictive model generation system of the present disclosure. The precise form of application is not limited in the present disclosure.

It is to be noted that the logic blocks, modules, circuits and steps of any method described in the embodiments can be implemented by hardware, software or combination of both. The wording of “in communication with”, “connected to”, “coupled to”, “electrically connected to” or other similar wording is used to indicate direct or indirect signal exchange (for example, cable signals, wireless electromagnetic signals and optical signals) to achieve transfer and transmission of signals, data or control information to implement the logic blocks, modules, circuits and steps of the method. The wording in the specification does not limit the real connection type and all known connection types are encompassed in the scope of the present disclosure.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data filtering system in communication with a predictive model generation system for training a predictive model, wherein the data filtering system comprises:
a data pre-processing device, configured for transforming a plurality of records of first sample data corresponding to a first detection property into a plurality of first feature parameters, transforming a plurality of records of second sample data corresponding to a second detection property into a plurality of second feature parameters, and transforming a plurality of records of third sample data corresponding to a third detection property into a plurality of third feature parameters; and
a property selection device, configured for selecting at least two of the detection properties according to the first feature parameters, the second feature parameters and the third feature parameters,
wherein the predictive model generation system trains the predictive model based on the at least two detection properties selected by the property selection device.

2. The data filtering system according to claim 1, wherein the first sample data, the second sample data and the third sample data are generated at a sampling frequency within a detection duration.

3. The data filtering system according to claim 2, wherein the records of the first sample data, the records of the second sample data and the records of the third sample data are in equal numbers.

4. The data filtering system according to claim 1, wherein the data pre-processing device comprises:
a sequence generation module, configured for transforming the first sample data into a first test sequence comprising a plurality of records of first sequence data, transforming the second sample data into a second test sequence comprising a plurality of records of second sequence data, and transforming the third sample data into a third test sequence comprising a plurality of records of third sequence data according to a sequence interval.

5. The data filtering system according to claim 4, wherein the records of the first sequence data are fewer than the records of the first sample data, the records of the second sequence data are fewer than the records of the second sample data, and the records of the third sequence data are fewer than the records of the third sample data.

6. The data filtering system according to claim 4, wherein the records of the first sequence data, the records of the second sequence data and the records of the third sequence data are in equal numbers.

7. The data filtering system according to claim 4, wherein the data pre-processing device further comprises:
a feature transforming module, in communication with the sequence generation module and the property selection device, configured for transforming the first test sequence into the first feature parameters, transforming the second test sequence into the second feature parameters, and transforming the third test sequence into the third feature parameters.

8. The data filtering system according to claim 7, wherein
the first feature parameters comprise a first energy feature parameter, a first power feature parameter and a first signal-to-noise ratio feature parameter corresponding to the first detection property;
the second feature parameters comprise a second energy feature parameter, a second power feature parameter and a second signal-to-noise ratio feature parameter corresponding to the second detection property; and
the third feature parameters comprise a third energy feature parameter, a third power feature parameter and a third signal-to-noise ratio feature parameter corresponding to the third detection property.

9. The data filtering system according to claim 1, wherein the property selection device comprises:
a correlation calculation module, configured for calculating a first feature parameter average according to the first feature parameters, calculating a second feature parameter average according to the second feature parameters and calculating a third feature parameter average according to the third feature parameters.

10. The data filtering system according to claim 9, wherein the correlation calculation module calculates a first property dependent-correlation coefficient according the first feature parameter average and the second feature parameter average; calculates a second property dependent-correlation coefficient according the second feature parameter average and the third feature parameter average; and calculates a third property dependent-correlation coefficient according the first feature parameter average and the third feature parameter average.

11. The data filtering system according to claim 10, wherein
the correlation calculation module calculates a first electricity generation-correlation coefficient according to the first feature parameters and a plurality of electricity generation-feature parameters; calculates a second electricity generation-correlation coefficient according to the second feature parameters and the electricity generation-feature parameters; and calculates a third electricity generation-correlation coefficient according to the third feature parameters and the electricity generation-feature parameters.

12. The data filtering system according to claim 11, wherein the electricity generation-feature parameters comprise an electricity generation-energy feature parameter, an electricity generation-power feature parameter, and an electricity generation-signal-to-noise ratio feature parameter.

13. The data filtering system according to claim 11, wherein the property selection device further comprises:
a property selection module, in communication with the correlation calculation module, configured for defining a first candidate combination to include the first detection property and the second detection property, defining a second candidate combination to include the second detection property and the third detection property, and defining a third candidate combination to include the first detection property and the third detection property.

14. The data filtering system according to claim 13, wherein the property selection device further comprises:
a property estimation module in communication with the correlation calculation module, wherein
the property estimation module calculates a first merit score of the first candidate combination according to a merit score formula, the first electricity generation-correlation coefficient, the second electricity generation-correlation coefficient, and the first property dependent-correlation coefficient;
the property estimation module calculates a second merit score of the second candidate combination according to the merit score formula, the second electricity generation-correlation coefficient, the third electricity generation-correlation coefficient, and the second property dependent-correlation coefficient; and
the property estimation module calculates a third merit score of the third candidate combination according to the merit score formula, the first electricity generation-correlation coefficient, the third electricity generation-correlation coefficient, and the third property dependent-correlation coefficient.

15. The data filtering system according to claim 14, wherein the property selection module sorts the first candidate combination, the second candidate combination, and the third candidate combination according to the first merit score, the second merit score, and the third merit score.

16. The data filtering system according to claim 15, wherein the property selection module is in communication with the predictive model generation system, wherein
when the first merit score of the first candidate combination is the highest among the merit scores, the property selection module transmits the first detection property and the second detection property prior to other detection property to the predictive model generation system to train the predictive model;
when the second merit score of the second candidate combination is the highest among the merit scores, the property selection module transmits the second detection property and the third detection property prior to other detection property to the predictive model generation system to train the predictive model; and
when the third merit score of the third candidate combination is the highest among the merit scores, the property selection module preferentially transmits the first detection property and the third detection property prior to other detection property to the predictive model generation system to train the predictive model.

17. The data filtering system according to claim 1, wherein the data pre-processing device is in communication with a data capturing device, and the data pre-processing device receives the sample data from the data capturing device.

18. A data selection method used with a data filtering system in communication with a predictive model generation system for training a predictive model, wherein the data selection method comprises steps of:
transforming a plurality of records of first sample data corresponding to a first detection property into a plurality of first feature parameters, transforming a plurality of records of second sample data corresponding to a second detection property into a plurality of second feature parameters, and transforming a plurality of records of third sample data corresponding to a third detection property into a plurality of third feature parameters;
selecting at least two of the detection properties according to the first feature parameters, the second feature parameters, and the third feature parameters; and
transmitting the at least two detection properties to the predictive model generation system which trains the predictive model based on the at least two detection properties.

19. A state prediction system, comprising:
a data filtering system, comprising:
a data pre-processing device, configured for transforming a plurality of records of first sample data corresponding to a first detection property into a plurality of first feature parameters, transforming a plurality of records of second sample data corresponding to a second detection property into a plurality of second feature parameters, and transforming a plurality of records of third sample data corresponding to a third detection property into a plurality of third feature parameters; and
a property selection device, configured for selecting at least two of the detection properties according to the first feature parameters, the second feature parameters, and the third feature parameters; and
a predictive model generation system, in communication with the data filtering system, configured for training a predictive model based on the at least two detection properties selected by the property selection device.
